(19) United States
(12) Patent Application Publication
(10) Pub. No.: US 2006/0214920 A1
(43) Pub. Date: Sep. 28, 2006

(54) TOUCH SENSING APPARATUS

(76) Inventors: Kuan-Hong Hsieh, Shenzhen (CN); Shi-Quan Lin, Shenzhen (CN); Han-Che Wang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/163,709

(22) Filed: Oct. 27, 2005

(30) Foreign Application Priority Data
Mar. 25, 2005 (CN) 200510033852.1

(51) Int. Cl. G09G 5/00

(52) U.S. Cl. 345/173

(57) ABSTRACT

A preferred embodiment of a touch sensing apparatus includes a plurality of sensing units (10), and a plurality of grounding lines (205). Each sensing unit includes an antenna (201), a controlling circuit, a detector (203), and a feedback line (204). The antenna is for receiving a noise of a user's finger. The controlling circuit preferably includes a diode (2021) and a capacitor (2022). The diode is for filtering out a static electrical signal of the user's finger and attenuating the noise, and the capacitor(2022) is for attenuating the noise from the diode. The detector is for converting the noise into a digital signal, and transmitting the digital signal to an MCU (Microprogrammed Control Unit) (206). The feedback line forms a positive feedback circuit with the antenna, thereby improving the accuracy of sensitivity of the sensing unit. The grounding lines are for insulating the sensing units.

### FIELD OF THE INVENTION

The present invention relates generally to touch sensing apparatuses such as those used in certain personal computers, and particularly to a touch sensing apparatus for sensing a noise generated by a user's touch.

### DESCRIPTION OF RELATED ART

There are several available touch-sense technologies which may be employed for use as a position indicator in an apparatus such as a personal computer. Resistive-membrane position sensors are known and used in several applications. However, these sensors generally have poor resolution. In addition, the sensor surface is exposed to the user and is thus subject to wear. Further, resistive-membrane touch sensors are relatively expensive. A one-surface sensor configuration requires a user to be grounded relative to the sensor for reliable operation. This cannot be guaranteed in applications such as with portable computers. An example of a one-surface sensor configuration is the UnMouse product available from MicroTouch, of Wilmington, Mass.

A touch sensitive control device translates touch location into output signals. The device includes a substrate which supports first and second interleaved, closely spaced, non-overlapping arrays of conductive plates. An insulating layer overlies the first and second arrays so that when the outer surface of the insulating layer is touched, the capacitance of at least one of the columns of plates of the first array and the rows of plates of the second array underlying the insulating layer at the location being touched exhibits a change of capacitance with respect to ambient ground. Based upon the measured capacitance of each column of the first array and row of the second array, the microcomputer produces output signals which represent the coordinates of the location being touched. These output signals can be used, for example, to control the position of a cursor on a display screen of a personal computer or to make selected function commands.

In a second kind of conventional apparatus, a tablet for sensing the position of a stylus is provided. The stylus alters the transcapacitance coupling between row and column electrodes, which are scanned sequentially. In a third kind of conventional apparatus, a radial electrode arrangement is provided adjacent the space bar of a keyboard. The radial electrode arrangement is part of a trackball system, and can be activated by a user touching the trackball with his/her thumb. This third kind of apparatus teaches the use of total touch capacitance as an indication of the touch pressure, in order to control the velocity of motion of a display screen cursor. Pulsed sequential polling is employed to address the effects of electrical interference.

What is still needed is a touch sensing apparatus with reduced circuitry complexity, low power consumption, improved sense accuracy, improved efficiency, and lower manufacturing costs.

### SUMMARY OF INVENTION

A preferred embodiment of a touch sensing apparatus includes a plurality of sensing units, and a plurality of grounding lines. Each sensing unit includes an antenna, a controlling circuit, a detector, and a feedback line. The antenna is for receiving a noise of a user's finger. The controlling circuit preferably includes a diode and a capacitor. The diode is for filtering out a static electrical signal of the user's finger and attenuating the noise, and the capacitor is for attenuating the noise from the diode. The detector is for converting the noise into a digital signal, and transmitting the digital signal to an MCU (Microprogrammed Control Unit). The feedback line forms a feedback circuit with the antenna, thereby improving the accuracy of sensitivity of the sensing unit. The grounding lines are for insulating the sensing units.

Other advantages and novel features will be drawn from the following detailed description of the preferred embodiment with reference to the attached drawings, in which:

### BRIEF DESCRIPTION OF DRAWINGS

FIG. 1 is a schematic plan view of a touch sensing apparatus in accordance with a preferred embodiment of the present invention; and

FIG. 2 is a circuit diagram of one sensing unit of the touch sensing apparatus of FIG. 1.

### DETAILED DESCRIPTION

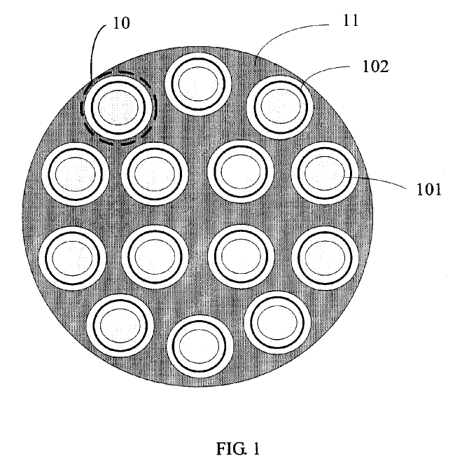

FIG. 1 is a schematic plan view of a touch sensing apparatus (hereafter, “the apparatus”) in accordance with a preferred embodiment of the present invention. In this embodiment, the apparatus includes a plurality of sensing units 10 and an isolation unit 11. Each sensing unit 10 (e.g., as indicated by a broken line in FIG. 1) includes a sensor 101 and a feedback unit 102. The feedback unit 102 encircles and is isolated from the sensor 101. The sensor 101 is used for inducing a noise of a user's finger, and transmitting the noise. The feedback unit 102 is for adjusting an accuracy of inducing of the noise of the user's finger. The isolation unit 11 is provided for isolating each sensing unit 10, thereby preventing interference between each two adjacent sensing units 10.

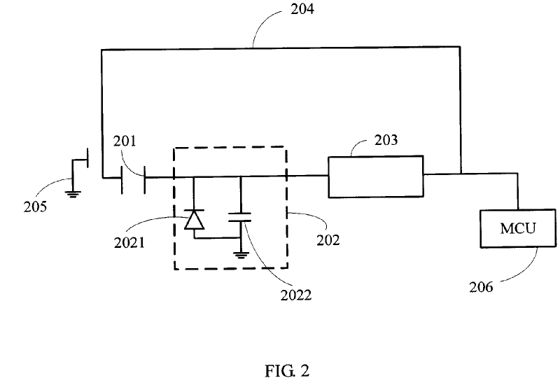

FIG. 2 is an exemplary circuit diagram of the sensing unit 10. The circuit mainly includes an antenna 201, a clamping circuit 202, a detector 203, a feedback line 204, and a grounding line 205. The antenna 201 is connected to the clamping circuit 202. The clamping circuit 202 is connected to an input end of the detector 203. An output end of the detector 203 is respectively connected to a Microprogrammed Control Unit (MCU) 206 and one end of the feedback line 204. The feedback line 204 corresponds to the feedback unit 102, and forms a positive feedback circuit with the antenna 201. The grounding line 205 corresponds to the isolation unit 11, and is for insulating the sensing unit 10.

The human body is itself electrically conductive with a noise and a static electrical signal. Therefore, when a user touches the sensor 101, namely the antenna 201, the noise and the static electrical signal of the user flow through the antenna 201. The antenna 201 transmits the noise and the static electrical signal to the clamping circuit 202. However, the static electrical signal can cause interference to the noise, and can even cause the detector 203 to break down. In addition, a strong noise may adversely influence a result output to the MCU 206; that is, the sensitivity of the sensing unit 10 may be diminished. Accordingly, the clamping circuit 202 is for eliminating the static electrical signal and attenuating the noise, and thus improving the accuracy of sensitivity of the sensing unit 10. The clamping circuit 202 includes a diode 2021 having an anode and a cathode, and a capacitor 2022 having two ends. The anode is connected to the antenna 201, and the cathode is connected to ground. Upon receiving the static electrical signal and the noise, the diode 2021 filters out the static electrical signal to ground so as to avoid breakdown of the detector 203, and attenuates the noise and transmits the attenuated noise to the capacitor 2022. The capacitor 2022 leaks a portion of the attenuated noise through to ground. Thus the attenuated noise is further attenuated, thereby obtaining an accurate sensitivity. The detector 203 has a high input impedance, so as to easily detect the further attenuated noise received from the input end of the detector 203. Then the detector 203 converts the further attenuated noise into a digital signal, and transmits the digital signal through the output end of the detector 203 to the MCU 206 for the MCU 206 to perform corresponding control. Furthermore, because the feedback line 204 forms a positive feedback circuit with the antenna 201, the noise generated as the user touches the edge of the sensing unit 10 is attenuated, thereby further improving the accuracy of sensitivity of the sensing unit 10.

Although the present invention has been specifically described on the basis of a preferred embodiment, the invention is not to be construed as being limited thereto. Various changes or modifications may be made to the embodiment without departing from the scope and spirit of the invention.

What is claimed is:

1. A touch sensing apparatus, the apparatus comprising a plurality of sensing units, each sensing unit comprising:
an antenna for receiving a noise of a user's finger;
a detector for converting the noise into a digital signal and transmitting the digital signal to an MCU (Microprogrammed Control Unit), wherein an input of the detector connects to the antenna, and an output of the detector is for connecting to the MCU; and
a feedback line for improving an accuracy of inducing the noise of the finger, wherein one end of the feedback line forms a feedback circuit with the antenna, and the other end of the feedback line connects to the output of the detector.

2. The touch sensing apparatus described as in claim 1, further comprising a plurality of controlling circuits respectively corresponding to the plurality of sensing units, wherein each of the controlling circuits comprises:
a diode for filtering out a static electrical signal from the user's finger and attenuating the noise, wherein an anode of the diode is connected to the antenna, and a cathode of the diode is grounded; and
a capacitor for attenuating the noise from the diode, wherein one end of the capacitor connects to the input of the detector, and the other end of the capacitor is grounded.

3. The touch sensing apparatus described as in claim 1, wherein the detector comprises a high impedance input circuit.

4. The touch sensing apparatus described as in claim 1, further comprising a plurality of grounding lines for insulating the sensing units.

5. A touch sensing unit comprising:
an antenna for receiving a noise of a user's finger;
a detector for converting the noise into a digital signal and transmitting the digital signal to an MCU (Microprogrammed Control Unit), wherein an input of the detector connects to the antenna, and an output of the detector is for connecting to the MCU; and
a feedback line for improving an accuracy of inducing the noise of the finger, wherein one end of the feedback line forms a feedback circuit with the antenna, and the other end of the feedback line connects to the output of the detector.

6. The touch sensing unit described in claim 5, further comprising a controlling circuit, the controlling circuit comprising:
a diode for attenuating the input noise and filtering out any static input from the finger, wherein an anode of the diode connects to the antenna, and a cathode of the diode is grounded; and
a capacitor for attenuating the noise, wherein one end of the capacitor connects to the input of the detector, and the other end of the capacitor is grounded.

7. The touch sensing unit described in claim 5, wherein the detector comprises a high impedance input circuit.
